(19) United States
(12) Patent Application Publication
(10) Pub. No.: US 2004/0263913 A1
(43) Pub. Date: Dec. 30, 2004

(54) Image capturing apparatus, method for controlling the image capturing apparatus and a computer program for controlling the image capturing apparatus

(76) Inventor: Sannoh Masato, Ootaku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/875,193

(22) Filed: Jun. 25, 2004

(30) Foreign Application Priority Data
Jun. 26, 2003 (JP) JP 2003-183320

(51) Int. Cl. H04N 1/21; H04N 1/40

(52) U.S. Cl. 358/302; 358/296

(57) ABSTRACT

A digital camera as an image capturing apparatus detects a voltage of a battery arranged in the image capturing apparatus. If the voltage detected is equal to or less than a predetermined voltage, the digital camera terminates transmitting image data into an external apparatus, stores the image data into a storage memory if not yet stored in the storage memory, and disconnects a network connection with the external apparatus. If the voltage detected is greater than the predetermined voltage, the digital camera connects to the network and transmits image data specified by user in advance. When the detected voltage is equal to or less than the predetermined voltage even if during the transmitting, the digital camera terminates the transmitting, stores the image data, and disconnects the network. The digital camera then retransmits the image data not yet transmitted after the digital camera is turned on again, and displays a message, which shows that all of the image data has been transmitted completely, on a display unit.

### BACKGROUND OF THE INVENTION

1. Field of the Invention

The present invention relates to an image capturing apparatus having a communicating function and relates to a method and computer program to prevent disappearance of image data by a drop in voltage of a battery during data transmission in the image capturing apparatus.

2. Description of the Background Art

It is desirable for an image capturing apparatus such as a digital camera to be small and lightweight because of portability, and it is therefore desirable that a battery as a power source of the digital camera is as small and lightweight as possible. However, that results in a problem that the digital camera having a communicating function may not be able to transmit an image data captured completely because of small battery capacity and brownout, because such a kind of digital camera requires a measurable amount of power.

Japanese Patent Laid-Open No. 2002-209128 gazette discloses a method of controlling transmitting image data gradually to utilize energy of the battery effectively, by controlling the number of image data to be transmitted based on a voltage of a battery. In this manner, the digital camera of this background art can prevent the problem of not being able to store the image data into the storing media by reason of a brownout occurring during storing of the image data into the storing media.

However, such a digital camera may not be able to transmit the image data completely, because a communication time is different every time based on a communication condition, i.e. the transmission rate becomes slow as the communication time becomes long. In such a case the digital camera becomes in a state in which it cannot communicate, even if the digital camera controls the number of the image data to be transmitted preliminarily.

### SUMMARY OF THE INVENTION

Accordingly, it is an object of the present invention to provide a novel image capturing apparatus having a communication function to transmit image data into an external apparatus connected with the image capturing apparatus. The image capturing apparatus can transmit the image data without omission, by terminating transmitting the image data to protect the image data, storing the image data into a storage memory if the image data is not stored in the storage memory, and transmitting the image data not yet transmitted after the digital camera is turned on again.

The novel image capturing apparatus, such as a digital camera having a communication function for transmitting image data that is captured, has a battery as a power source, a memory, a data storing control, a battery voltage detector, and a communication mechanism. The memory is configured to hold data for processing of the image capturing apparatus. The data includes not only the image data but also various parameter data for the image capturing apparatus. The data storing control is configured to store the image data into the memory. The battery voltage detector is configured to detect a voltage of the battery. The communication mechanism is configured to transmit the image data to an external apparatus, as data transmission. The external apparatus is configured to hold the image data as a storage apparatus, such as a server computer.

Then, the communication mechanism terminates the data transmission when the battery voltage detector detects that the voltage of the battery is equal to or less than a predetermined voltage while the communication mechanism transmits the image data into the external apparatus. After the termination, the data storing control stores the image data into the memory, if the image data that is not yet transmitted is not yet stored in the memory, before the image capturing apparatus is turned off by reason of brownout. After the image capturing apparatus is turned on with a new battery or a charged battery, the communication mechanism retransmits the image data not yet transmitted to the external apparatus.

In this manner, the image capturing apparatus can transmit all of the image data specified by the user, without omission, even if it becomes impossible for an image capturing apparatus to drive itself and the image capturing apparatus was powered down unfortunately because of a drop in the voltage of the battery (a brownout).

It may be desirable that the data storing control stores table data corresponding to the image data, into the memory, before the image capturing apparatus is turned off by reason of brownout. Then, the communication mechanism retransmits the image data not yet transmitted to the external apparatus, based on the table data, after the image capturing apparatus is turned on. In this manner, the image capturing apparatus can transmit all of the image data specified by the user more easily, automatically, and more certainly without omission, even if it becomes impossible for an image capturing apparatus to drive itself and the image capturing apparatus was powered down unfortunately because of a drop in the voltage of the battery.

It may also be desirable that the image capturing apparatus has a display, and the display displays a message that shows the image data was not transmitted completely into the external apparatus. In this manner, the image capturing apparatus can alert the user of this transmission error.

It may also be desirable that the display displays a number of the image data not yet transmitted into the external apparatus. In this manner, the image capturing apparatus can let the user easily know the number of the image data not yet transmitted during a transmission error.

It may also be desirable that the display displays a number of the image data already transmitted into the external apparatus. In this manner, the image capturing apparatus can let the user know the number of the image data already transmitted during a transmission error.

It may also be desirable that the display displays the above-mentioned number, before the image capturing apparatus is turned off by reason of brownout. In this manner, the image capturing apparatus can let the user notice the above-mentioned number in the early stages during a transmission error.

It may also be desirable that the display displays the above-mentioned number, after the image capturing apparatus is turned on again. In this manner, the image capturing apparatus can let the user know the above-mentioned number during a transmission error certainly, even if a long time passes after a power down.

It may also be desirable that the image capturing apparatus also include a communication condition determining mechanism. The communication condition determining mechanism determines whether the communication mechanism is in a state that is able to transmit the image data into the external apparatus, when the image data that should be transmitted to the external apparatus but is not yet transmitted exists in the memory, after the image capturing apparatus is turned on again. Then, the communication mechanism postpones the data transmission when the communication condition determining mechanism determines that the communication mechanism is not in a state that is able to transmit the image data. After the communication mechanism becomes in a state that is able to transmit the image data, the communication mechanism retransmits the image data that should be transmitted to the external apparatus but is not yet transmitted, into the external apparatus. In this manner, the image capturing apparatus can let the user know the above-mentioned number. In this manner, the image capturing apparatus can transmit all of the image data specified by the user more easily, automatically, and more certainly without omission, even if it becomes impossible for an image capturing apparatus to drive itself and the image capturing apparatus was powered down unfortunately because of a drop in the voltage of the battery.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIGS. 1A-1C show an external view of a digital camera related to one embodiment of the present invention;

FIGS. 2A-2D are a block diagram of the digital camera of the one embodiment of the present invention;

FIG. 3 is a flow chart explaining an operation of the digital camera of the one embodiment of the present invention;

FIGS. 4A and 4B are a flow chart explaining an operation of the digital camera of the one embodiment of the present invention after turning on the digital camera; and

FIG. 5 shows an example of a message displayed on a display unit when a digital camera is powered down by a drop in voltage of a battery, according to the present invention.

### DETAILED DESCRIPTION OF THE PREFERRED EMBODIMENT

Referring now to the accompanying drawings, a description is made of a detailed description of the preferred embodiment of the present invention. The above and further objects and novel features of the invention will more fully appear from the following detailed description when the same is read in connection with the accompanying drawing. It is to be expressly understood, however, that the drawings are for purpose of illustration only and are not intended as a definition of the limits of the present invention.

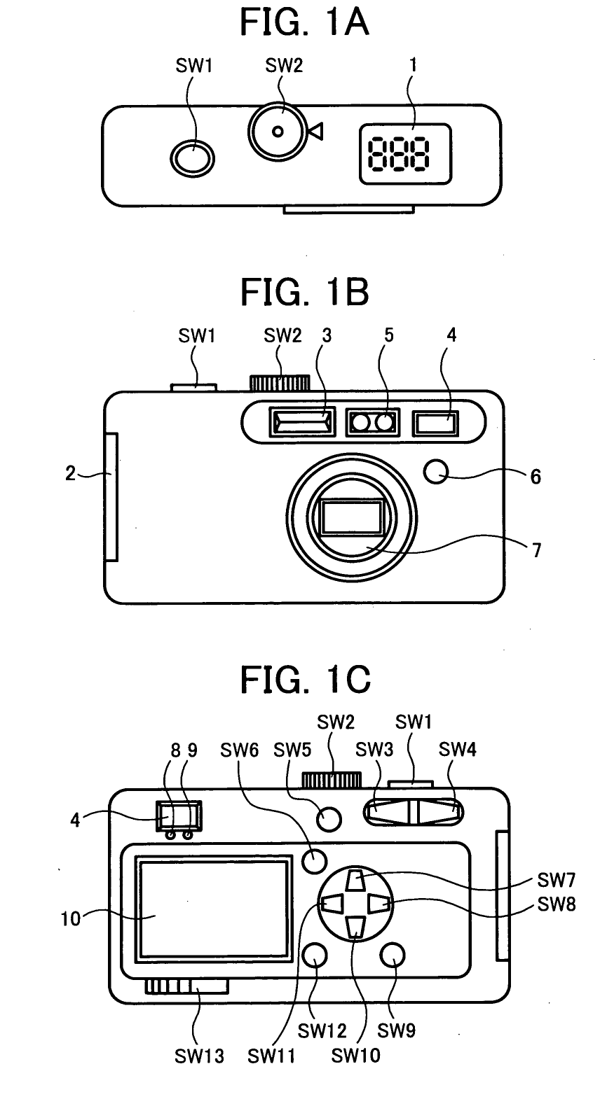

FIGS. 1A-1C show an external appearance of a digital camera related to one embodiment of the present invention. FIG. 1A is a top plan view of the digital camera, FIG. 1B a front view of the digital camera, and FIG. 1C is back view of the digital camera. Identical reference numerals refer to the same or a corresponding composition element. The digital camera includes a shutter release switch SW1, a mode dial SW2, an indication unit 1, a card/battery lid 2, a stroboscope 3, an optical finder 4, a range-finder 5, a wireless remote control signal receiving unit 6, a lens barrel unit 7, an AF (auto-focus) indication LED 8, a stroboscope indication LED 9, a LCD monitor display unit 10, a power supply switch SW13, a zoom-out switch SW3, a zoom-in switch SW4, a self-timer/deletion switch SW5, a menu switch SW6, an up/stroboscope switch SW7, a right switch SW8, a display switch SW9, a down/macro-mode switch SW10, and a left/preview switch SW11. The above-mentioned switches may be described as an operation key unit SW1-SW13 hereinafter.

The shutter release switch SW1 is configured to input a command to shoot a subject. The mode dial SW2 is configured to input a command to switch a capturing mode. The indication unit 1 is configured to indicate a number of available memory picture locations that remain in a memory. The card/battery lid 2 is configured to be able to open or close when a memory card or battery arranged in the digital camera is swapped. The stroboscope 3 is configured to emit light to light up the subject. The optical finder 4 is configured to view the subject to decide a shooting angle. The range-finder 5 is configured to measure a distance to the subject. The wireless remote control signal receiving unit 6 is configured to receive a signal from a wireless remote control unit (not shown) operated by a user. The lens barrel unit 7 is configured to receive a lens group. The AF indication LED 8 is configured to emit light for indicating AF information such as a focus condition during processing of auto focusing. The stroboscope indication LED 9 is configured to emit light for indicating a charging information such as a charging condition during charging the stroboscope. The display unit 10 is configured to display an image stored in a built-in nonvolatile memory 120 or a memory card 121a described below and a monitored image of the subject that will be shot to confirm a condition of the subject.

The power supply switch SW13 is configured to turn on and off the digital camera. The zoom-out switch SW3 and the zoom-in switch SW4 are configured to change magnification of the subject respectively by moving the lens group to a zoom-out angle position and a zoom-in angle position. The self-timer/deletion switch SW5 is configured to process two functions in different modes respectively, is configured to input an order for self-timer shooting in a shooting mode, and is configured to input an order for deletion of an image file shot in a menu mode. The menu switch SW6 is configured to switch between a shooting mode to shoot and the menu mode for setting up the digital camera. The up/stroboscope switch SW7 is configured to process two functions in different modes respectively, is configured to input an order for moving a cursor line aloft in the menu mode, and is configured to input an order for shooting with/without the stroboscope in the shooting mode. The right switch SW8 is configured to input an order for moving a cursor line to the right in the menu mode. The display switch SW9 is configured to input an order for switching the LCD display monitor 10 on/off. The down/macro-mode switch SW10 is configured to process two functions in different modes respectively, is configured to input an order for moving a cursor line beneath in the menu mode, and is configured to input an order for switching modes between the shooting mode and a macro shooting mode. The left/preview switch SW11 is configured to process two functions in different modes respectively, is configured to input an order for moving a cursor line to the left in the menu mode, and is configured to input an order for displaying the image shot before in the shooting mode.

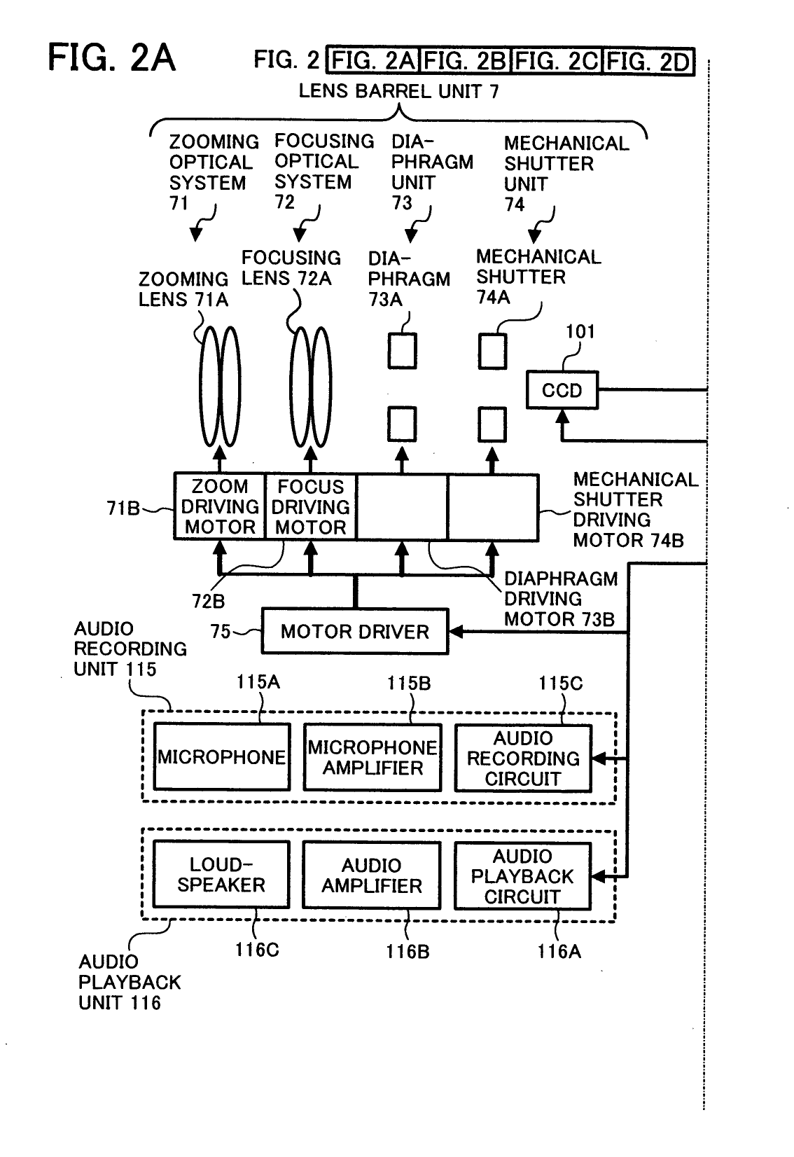

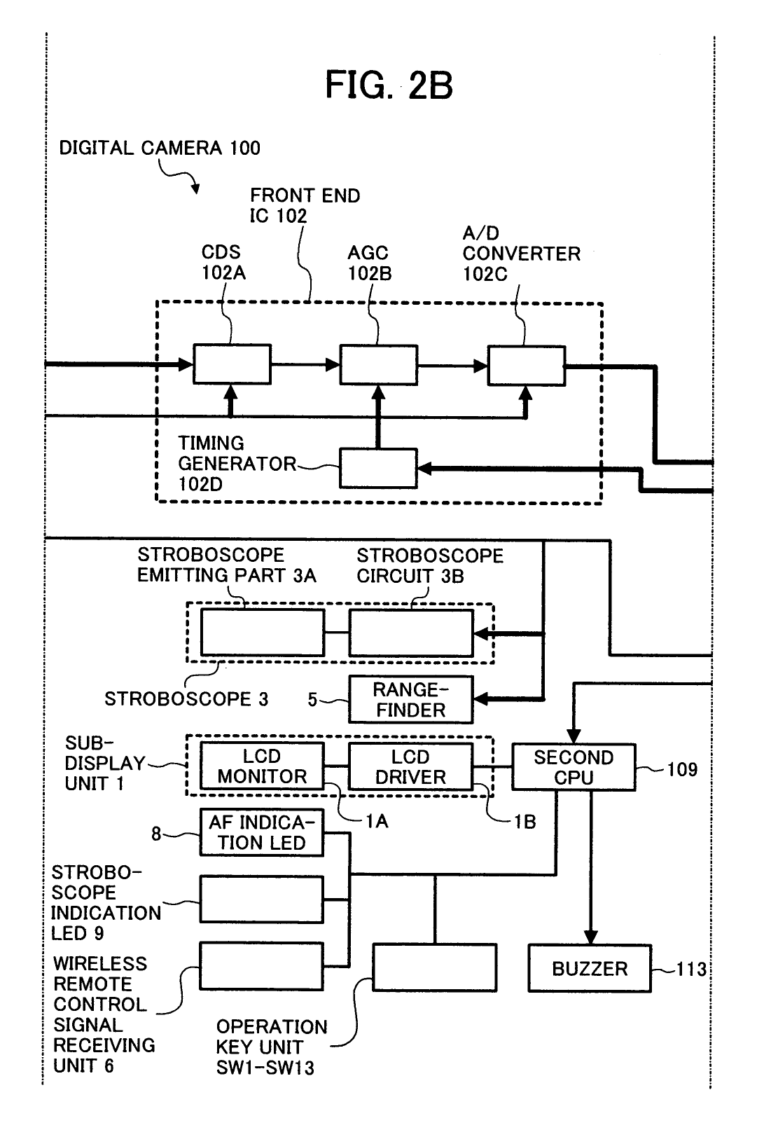

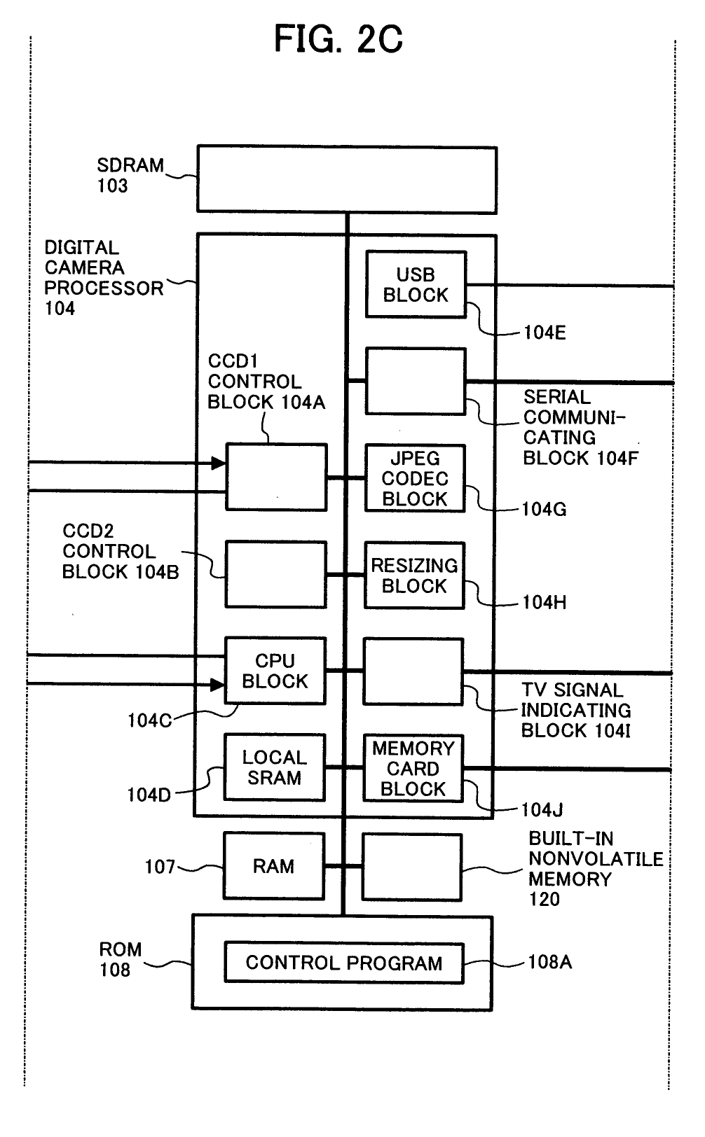

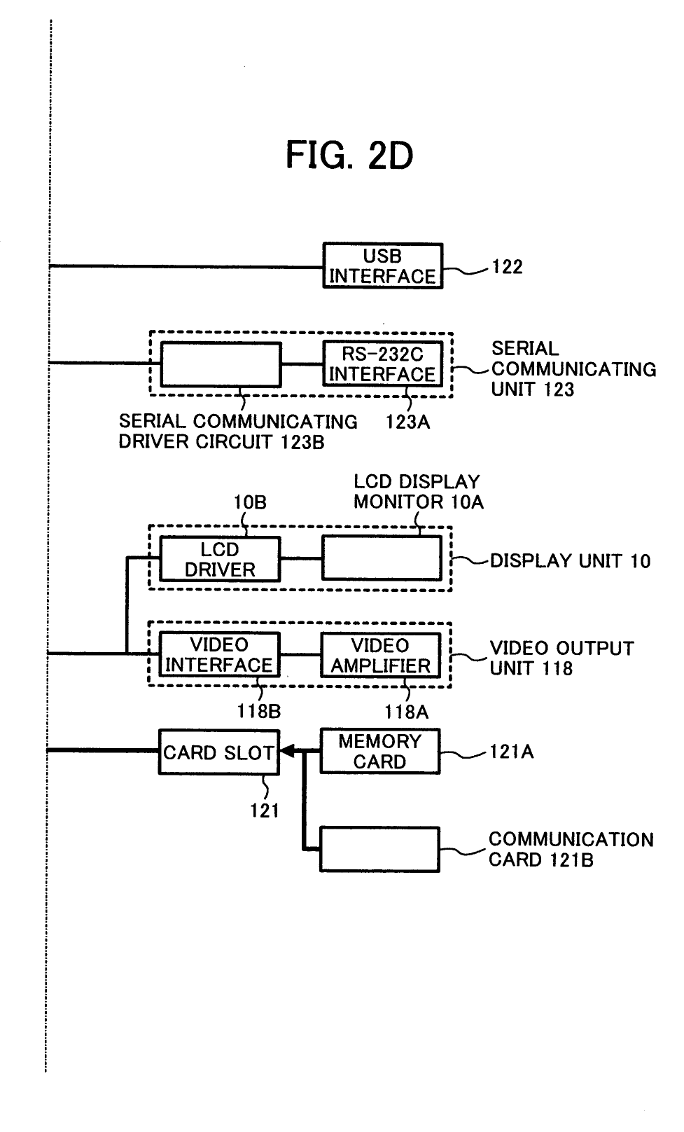

FIGS. 2A-2D are a block diagram of a digital camera related to one embodiment of the present invention. The digital camera 100 includes the stroboscope 3, the range-finder 5, the wireless remote control signal receiving unit 6, the lens barrel unit 7, the AF indication LED 8, the stroboscope indication LED 9, the display unit 10, the operation key unit SW1-SW13, a front end IC 102, a SDRAM 103, a digital camera processor 104, a RAM 107, a ROM 108, a second CPU 109, a buzzer 113, an audio recording unit 115, an audio playback unit 116, a video output unit 118, a built-in nonvolatile memory 120, a card slot 121, an USB interface 122, and a serial communicating unit 123.

The stroboscope 3 includes a stroboscope emitting part 3A and a stroboscope circuit 3B configured to control charging and emission of light of the stroboscope emitting part 3A. The lens barrel unit 7 includes a zooming optical system 71, a focusing optical system 72, a diaphragm unit 73, a mechanical shutter unit 74, and a motor driver 75. The zooming optical system 71 further includes a zooming lens 71A configured to capture an optical image of the subject and a zooming driving motor 71B configured to drive the zooming lens 71A for capturing. The focusing optical system 72 further includes a focusing lens 72A configured to focus on the subject and a focus driving motor 72B configured to drive the focusing lens 72A. The diaphragm unit 73 further includes a diaphragm 73A and a diaphragm driving motor 73B configured to drive the diaphragm 73A. The mechanical shutter unit 74 further includes a mechanical shutter 74A and a mechanical shutter driving motor 74B configured to drive the mechanical shutter 74A. The motor driver 75 is configured to be controlled by a driving instruction from a CPU block 104C included in a digital camera processor 104 described below, based on an input from the wireless remote control signal receiving unit 6 or the operation key unit SW1-SW13.

The display unit 10 further includes a LCD display monitor 10A and a LCD driver 10B including a driving circuit to drive the LCD display monitor 10A. The front end IC 102 further includes a CDS 102A, an AGC 102B, an A/D converter 102C, and a timing generator 102D. The CDS 102A is configured to process Correlated Double Sampling to remove noise of an image. The AGC 102B is configured to process Automatic Gain Control. The A/D converter 102C is configured to convert an analog signal into a digital signal. The timing generator 102D is configured to generate a drive timing signal for the CDS 102A, the AGC 102B, the A/D converter 102C, and a CCD 101.

The SDRAM 103 is configured to store an image data temporarily when the image data is given various effects at a digital camera processor 104.

The digital camera processor 104 further includes a CCD1 control block 104A, a CCD2 control block 104B, the CPU block 104C, a local SRAM 104D, an USB block 104E, a serial communicating block 104F, a JPEG codec block 104G, a resizing block 104H, a TV signal indicating block 104I, and a memory card block 104J. The CCD1 control block 104A is configured to apply a white balance correction and a gamma correction to an image data that is output from the front end IC 102 and to transmit both a vertically synchronizing signal and a horizontally synchronizing signal to the front end IC 102. The CCD2 control block 104B is configured to convert image data into brightness data and chrominance difference data by filtering technology. The CPU block 104C is configured to control various functions (i.e., such as the motor driver 75, the audio recording unit 115, the audio playback unit 116, the stroboscope 3, and the range-finder 5) of the digital camera 100, in accordance with a control program 108A loaded from a ROM 108, after the digital camera is turned on. The local SRAM 104D is configured to store various data that is necessary for the above-mentioned control temporarily. The USB block 104E is configured to control communication with an external apparatus such as a personal computer via a USB cable. The serial communicating block 104F is configured to control serial communication with an external apparatus such as a personal computer. The JPEG codec block 104G is configured to process JPEG compression and decompression. The resizing block 104H is configured to enlarge and reduce the scale of the image data by data interpolation. The TV signal indicating block 104I is configured to convert the image data into a video signal for displaying on the display unit 10 and an external display apparatus such as a television. The memory card block 104J is configured to control a memory card 121a for storing the image data shot. The RAM 107 is configured to store various data that is necessary for total control temporarily. The ROM 108 is configured to keep the control programs 108A and various control parameters 108b; the control programs 108A are described by predetermined code that is readable by the CPU block 104C.

The second CPU 109 includes a one-chip element including a ROM and RAM, is configured to transmit output signals from the operation key unit SW1-SW13 and the wireless remote control signal receiving unit 6 to the CPU block 104C, and to output control signals to the indication unit 1, the AF indication LED 8, the stroboscope indication LED 9, and the buzzer 113, after converting a signal output from the CPU block 104C.

The audio recording unit 115 further includes a microphone 115A, a microphone amplifier 115B, and an audio recording circuit 115C. The microphone 115A is configured to receive an audio signal in accordance with a command input by a user. The microphone amplifier 115B is configured to amplify an audio signal that is input from the microphone 115A. The audio recording circuit 115C is configured to control recording of the audio signal amplified.

The audio playback unit 116 further includes an audio playback circuit 116A, an audio amplifier 116B, and a loudspeaker 116C. The audio playback circuit 116A is configured to convert an audio signal that is recorded, into a signal that the loudspeaker 116C can output. The audio amplifier 116B is configured to amplify the converted audio signal, to drive the loudspeaker 116C. The loudspeaker 116C is configured to output the amplified audio signal.

The video output unit 118 further includes a video amplifier 118A and a video interface 118B. The video amplifier 118A includes an amplifier configured to process 75-omega impedance conversion converting the video signal transmitted from the TV signal indicating block 104I. The video interface 118B includes an interface configured to connect to the external display apparatus such as the television.

The built-in nonvolatile memory 120 is configured to be able to store the image data that is shot, even if the memory card 121a is not housed into a card slot 121 described below, as storage media. The card slot 121 is configured to house the memory card 121A and a communication card 121B such as a wireless LAN network card, detachably. The USB interface 122 includes an interface configured to connect to an external apparatus such as a personal computer to communicate various sorts of information, via a USB cable. The serial communicating unit 123 further includes a RS-232C interface 123A and a serial communicating driver circuit 123B. The RS-232C interface 123A includes an interface configured to connect to an external apparatus such as a personal computer to communicate various information serially. The serial communicating driver circuit 123B includes a converter circuit configured to convert an output signal transmitted from the serial communicating block 104F by transducing voltage.

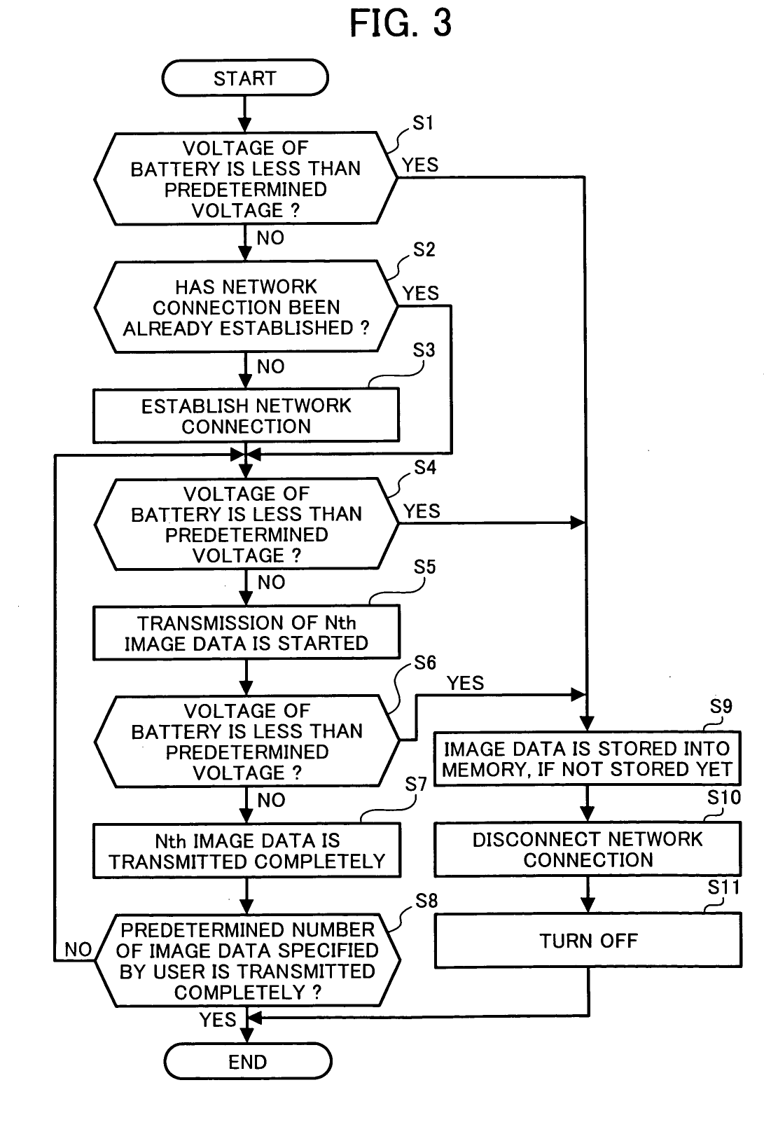

FIG. 3 is a flow chart explaining an operation of the digital camera 100 related to one embodiment of the present invention. The digital camera 100 detects a voltage of the battery housed into the digital camera after the user specifies a plurality of the image data for transmitting (S1). When the voltage detected is equal to or less than a predetermined voltage (Yes in step S1), the digital camera 100 stores the image data into the built-in nonvolatile memory 120 (step S9), and disconnects a network connection with the external apparatus (step S10), if a network connection has been established. After displaying a message, which shows the image data was not transmitted to the external apparatus completely, on display unit 10, the digital camera 100 turns off automatically (step S11). Otherwise, when the voltage detected is greater than the predetermined voltage (No in step S1), the operation progresses to step S2 next. If the network connection is not established (No in step S2), the digital camera 100 establishes the network connection with the external apparatus, e.g. via the wireless LAN network card, (step S3).

The digital camera 100 can transmit the image data by File Transfer Protocol into the external apparatus such as a server computer specified by user, one image data per once. Whenever one piece of image data is transmitted, the digital camera 100 processes the above-mentioned battery check before transmitting. Namely, the digital camera 100 determines whether the detected voltage of the battery is less than the predetermined voltage (step S4), and if the detected voltage is equal to or less than the predetermined voltage (Yes in step S4), the digital camera 100 stores the image data into the built-in nonvolatile memory 120 (step S9), if not yet stored in the built-in nonvolatile memory, and disconnects a network connection with the external apparatus (step S10), if network connection has been established. After displaying a message, which shows the image data was not transmitted to the external apparatus completely, on display unit 10, the digital camera 100 is turned off automatically (step S11).

If the detected voltage is more than the predetermined voltage (No in step S4), the digital camera 100 transmits the Nth image data to the external apparatus (step S5). N is an arbitrary number in the range of the number of images which a user specified. In addition, the digital camera monitors the voltage of the battery while transmitting the image data (step S6). When the detected voltage of the battery drops to be equal to or less than the predetermined voltage even if during the transmitting (Yes in step S6), the digital camera 100 terminates transmitting the image data and stores the image data into the built-in nonvolatile memory 120 (step S9) if not yet stored in the built-in nonvolatile memory, and disconnects the network connection with the external apparatus (step S10). After displaying a message, which shows the image data was not transmitted to the external apparatus completely, on display unit 10, the digital camera 100 is turned off automatically (step S11). Otherwise, after the Nth image data specified by the user is transmitted completely (step S7), the digital camera 100 determines whether the predetermined number of the image data specified by the user is transmitted completely (step S8). If not completed (No in step S8), the operation progresses to Step S4 next. If completed (Yes in step S8), the digital camera 100 displays a message, which shows that the whole image data has been transmitted completely, on the display unit 10, prior to ending the operation.

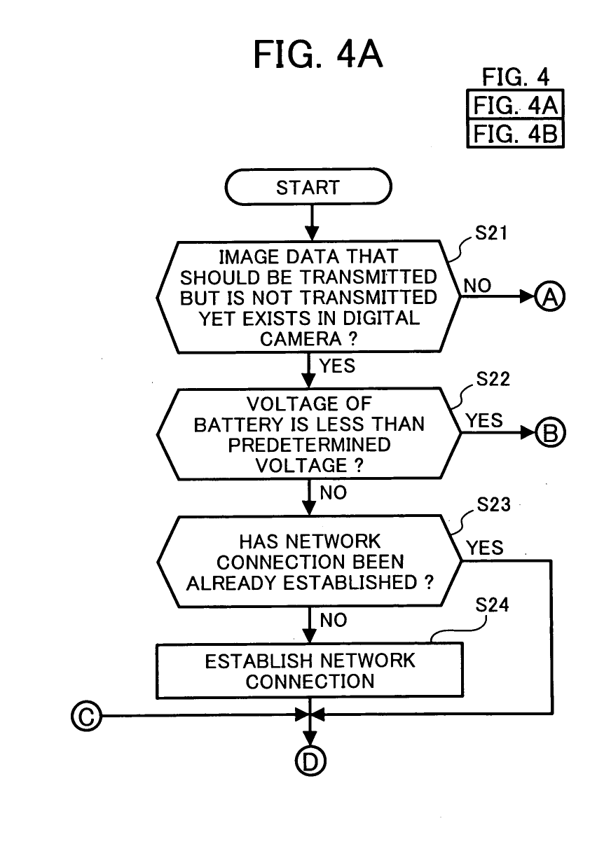

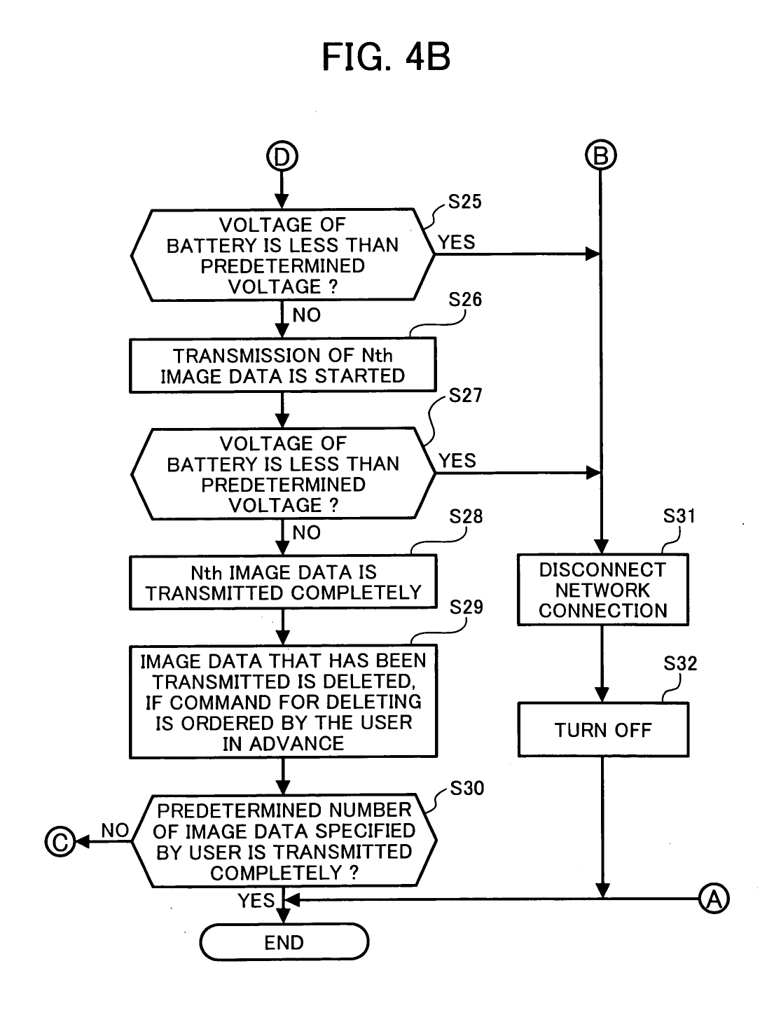

FIGS. 4A and 4B are a flow chart explaining an operation of a digital camera of the one embodiment of the present invention after turning on again with a new battery. At first, the digital camera detects whether image data that should have been transmitted to the external apparatus but that has not yet been transmitted exists in the digital camera (step S21). When such image data remains (Yes in step S21), the digital camera detects the voltage of the battery (step S22). If the detected voltage of the battery is less than the predetermined voltage (Yes in step S22), the network connection with the external apparatus is disconnected (step S31), if the network connection had been established. After displaying a message, which shows the image data was not transmitted to the external apparatus completely, on display unit 10, the digital camera 100 turns off automatically (step S32). Otherwise, when the voltage detected is greater than the predetermined voltage (No in step S22), the operation progresses to step S23 next. If the network connection is not established (No in step S23), the digital camera 100 establishes the network connection with the external apparatus, e.g. via the wireless LAN network card, (step S24).

The digital camera 100 can transmit the image data by File Transfer Protocol into the external apparatus such as a server computer specified by a user, one image data per once. Whenever one piece of image data is transmitted, the digital camera 100 processes the above-mentioned battery check before transmitting. Namely, the digital camera 100 determines whether the detected voltage of the battery is less than the predetermined voltage (step S25), if the detected voltage is equal to or less than the predetermined voltage (Yes in step S25), the digital camera 100 disconnects a network connection with the external apparatus (step S31), if the network connection had been established. After displaying a message, which shows the image data was not transmitted to the external apparatus completely, on display unit 10, the digital camera 100 turns off automatically (step S32).

If the detected voltage is more than the predetermined voltage (No in step S25), the digital camera 100 transmits the Nth image data to the external apparatus (step S26), one image data per once. The digital camera monitors the voltage of the battery while transmitting the image data (step S27). When the detected voltage of the battery drops to be less than the predetermined voltage even if during the transmitting (Yes in step S27), the digital camera 100 terminates transmitting the image data and disconnects a network connection with the external apparatus (step S31). After displaying a message, which shows the image data was not transmitted to the external apparatus completely, on display unit 10, the digital camera 100 turns off automatically (step S32). Otherwise, after the Nth image data specified by the user is transmitted completely (step S28), the digital camera deletes the image data that has been transmitted into the external apparatus if a command for deleting unnecessary image data is ordered by the user in advance (step S29). Then, the digital camera 100 determines whether the predetermined number of the image data specified by the user has been transmitted completely (step S20). If not completed (No in step S30), the operation progresses to step S25 next. If completed (Yes in step S30), the digital camera 100 displays a message, which shows that whole image data is transmitted completely, on the display unit 10, prior to ending the operation.

In addition, though the image data that was not transmitted is stored into the built-in nonvolatile memory 120 in the above-mentioned embodiment, the following method is also acceptable. Namely, a data table corresponding to the plurality of the image data not yet transmitted is stored into a predetermined area of the nonvolatile memory, and the digital camera 100 transmits the image data not yet transmitted into the external apparatus based on the data table after the digital camera 100 is turned on again.

Also, the memory card 121a may be used, instead of the built-in nonvolatile memory 120 that is used under the above-mentioned one embodiment, as a storage memory.

In this manner, the digital still camera of the present invention can transmit all of the image data specified by the user, without omission, by retransmitting the image data based on the detected voltage of the battery after the digital camera is turned on again, even if it becomes impossible for a digital camera to drive itself and the digital camera was powered down unfortunately because of a drop in the voltage of the battery.

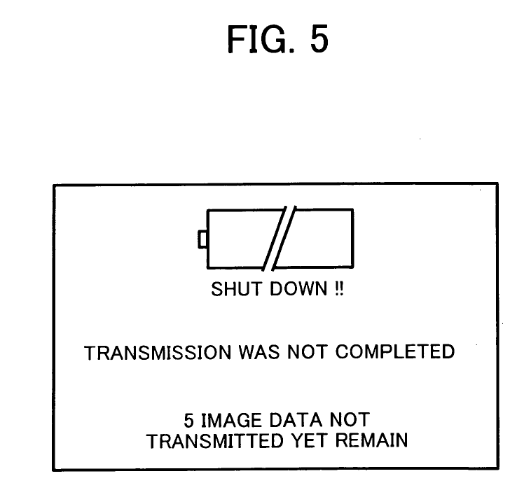

FIG. 5 shows an example of a message displayed on a display unit of the present invention when a digital camera is powered down because of a drop in voltage of the battery. When the digital camera terminates transmitting the image data because the voltage of the battery drops to be less than the predetermined voltage, the digital camera 100 displays a message, such as shown on FIG. 5, on the display unit 10 before powering down. The digital camera displays the following messages to let the user know, before powering down, for instance. “Shut Down!!”, “Transmission was not completed”, and “5 image data not transmitted yet remain”. It is recommended to display the number of the image data not yet transmitted, on the display unit 10.

In addition, it is also acceptable to display the number of the image data already transmitted. Also, it is acceptable to display the number of the image data not yet transmitted after the digital camera is turned on again. Also, it is acceptable that the transmitting of the image data is postponed until the digital camera 100 becomes in a state that is able to transmit the image data, transmits the image data not yet transmitted into the external apparatus after the digital camera 100 becomes in the state that is able to transmit the image data, even if the digital camera is not in a state to transmit the image data into the external apparatus because of an unknown cause.

Obviously, numerous modifications and variations of the present invention are possible in light of the above teachings. It is therefore to be understood that within the scope of the appended claims, the present invention may be practiced otherwise than as specifically described herein.

The present patent document is based on and claims priority to JP 2003-183320 filed in the Japanese Patent Office on Jun. 26, 2003, the entire contents of which are hereby incorporated herein by reference.

What is claimed is:

1. An image capturing apparatus having a battery as a power source, comprising:
means for storing data for processing of the image capturing apparatus;
means for controlling storing image data that is captured, into said means for storing;
means for detecting a voltage of said battery; and
means for transmitting said image data into an external apparatus, as a data transmission;
wherein said means for transmitting terminates data transmission when said means for detecting detects that the voltage of the battery is equal to or less than a predetermined voltage while said means for transmitting transmits the image data into the external apparatus, before the image capturing apparatus is turned off because of a brownout;
wherein said means for controlling controls storing said image data into said means for storing, if said image data that is not yet transmitted is not yet stored in said means for storing, before said image capturing apparatus is turned off because of the brownout; and
wherein said means for transmitting retransmits said image data not yet transmitted into said external apparatus after the image capturing apparatus is turned on.

2. An image capturing apparatus according to claim 1, wherein:
said means for controlling storing controls storing table data corresponding to the image data into the means for storing, before the image capturing apparatus is turned off because of the brownout; and
said means for transmitting retransmits the image data not yet transmitted into the external apparatus, based on the table data, after the image capturing apparatus is turned on.

3. An image capturing apparatus according to claim 1, further comprising:
means for displaying a message, which shows the image data was not transmitted completely into the external apparatus.

4. An image capturing apparatus according to claim 1, further comprising:
means for displaying a number of the image data not yet transmitted into said external apparatus.

5. An image capturing apparatus according to claim 4, wherein:
said means for displaying displays the number of the image data not yet transmitted, before the image capturing apparatus is turned off because of the brownout.

6. An image capturing apparatus according to claim 4, wherein:
said means for displaying displays the number of the image data not yet transmitted, after the image capturing apparatus is turned on again.

7. An image capturing apparatus according to claim 1, further comprising:
means for displaying a number of the image data already transmitted into the external apparatus.

8. An image capturing apparatus according to claim 7, wherein:
said means for displaying displays the number of the image data already transmitted, before the image capturing apparatus is turned off because of the brownout.

9. An image capturing apparatus according to claim 7, wherein:
said means for displaying displays the number of the image data already transmitted, after the image capturing apparatus is turned on again.

10. An image capturing apparatus according to claim 1, further comprising:
means for determining whether the means for transmitting is in a state that is able to transmit the image data into the external apparatus, when the image data that should be transmitted to the external apparatus but is not yet transmitted exists in said means for storing, after the image capturing apparatus is turned on again;
wherein said means for transmitting postpones data transmission when the means for determining determines that the means for transmitting is not in a state that is able to transmit the image data, and retransmits the image data into the external apparatus after the means for transmitting becomes in the state that is able to transmit the image data.

11. An image capturing apparatus having a communication function for transmitting image data that is captured, comprising:
a storage memory configured to hold data for processing of the image capturing apparatus;
a control processor configured to control a plurality of units for processing a plurality of functions arranged in the image capturing apparatus; and
a battery arranged in the image capturing apparatus detachably, and configured to supply electricity to the plurality of units, as a power source;
wherein when said control processor detects a voltage of said battery that is equal to or less than a predetermined voltage while transmitting the image data into an external apparatus as a data transmission, said control processor terminates the data transmission before the image capturing apparatus is turned off because of a brownout;
wherein said control processor orders to store the image data into said storage memory, if the image data that is not yet transmitted is not yet stored in said storage memory, before the image capturing apparatus is turned off because of the brownout; and
wherein said control processor orders to transmit the image data not yet transmitted into the external apparatus, after the image capturing apparatus is turned on again.

12. An image capturing apparatus according to claim 11, wherein:
said control processor orders to store a table data corresponding to the image data into said storage memory, before the image capturing apparatus is turned off because of the brownout; and
said control processor orders to retransmit the image data not yet transmitted into the external apparatus, based on the table data, after the image capturing apparatus is turned on again.

13. An image capturing apparatus according to claim 11, further comprising:
a display unit configured to display a message, which shows the image data was not transmitted completely into the external apparatus.

14. An image capturing apparatus according to claim 11, further comprising:
a display unit configured to display a number of the image data not yet transmitted into the external apparatus.

15. An image capturing apparatus according to claim 14, wherein:
said display unit displays the number of the image data not yet transmitted, before the image capturing apparatus is turned off because of the brownout.

16. An image capturing apparatus according to claim 14, wherein:
said display unit displays the number of the image data not yet transmitted, after the image capturing apparatus is turned on again.

17. An image capturing apparatus according to claim 11, further comprising:
a display unit configured to display a number of the image data already transmitted into the external apparatus.

18. An image capturing apparatus according to claim 17, wherein:
said display unit displays the number of the image data already transmitted, before the image capturing apparatus is turned off because of the brownout.

19. An image capturing apparatus according to claim 17, wherein:
said display unit displays the number of the image data already transmitted, after the image capturing apparatus is turned on again.

20. An image capturing apparatus according to claim 11, wherein:
said control processor orders to postpone the data transmission, when said control processor determines that the image capturing apparatus is not in a state that is able to transmit the image data, even if the image data that should be transmitted to the external apparatus but is not yet transmitted exists in said storage memory, after the image capturing apparatus is turned on again; and
said control processor orders to retransmit the image data into the external apparatus after said communicating means becomes in a state that is able to transmit the image data.

21. A method of controlling an image capturing apparatus having a communication function for transmitting image data that is captured, comprising:
transmitting the image data into an external apparatus, as a data transmission;
terminating the data transmission, when a voltage of a battery arranged in the image capturing apparatus detachably becomes equal to or less than a predetermined voltage, while the transmitting transmits the image data into the external apparatus;
storing the image data into a storage memory arranged in the image capturing apparatus, if the image data that is not yet transmitted is not yet stored in the storage memory, before the image capturing apparatus is turned off because of a brownout; and
re-transmitting the image data not yet transmitted to the external apparatus, after the image capturing apparatus is turned on again.

22. A method according to claim 21, further comprising:
storing a table data corresponding to the image data into the storage memory, before the image capturing apparatus is turned off because of the brownout; and
re-transmitting the image data not yet transmitted into the external apparatus, based on the table data, after the image capturing apparatus is turned on again.

23. A method according to claim 21, further comprising:
displaying a message which shows the image data was not transmitted completely into the external apparatus.

24. A method according to claim 21, further comprising:
displaying a number of the image data not yet transmitted into the external apparatus.

25. A method according to claim 24, wherein:
the displaying displays the number of the image data not yet transmitted, before the image capturing apparatus is turned off because of the brownout.

26. A method according to claim 24, wherein:
the displaying displays the number of the image data not yet transmitted, after the image capturing apparatus is turned on again.

27. A method according to claim 21, further comprising:
displaying a number of the image data already transmitted into the external apparatus.

28. A method according to claim 27, wherein:
the displaying displays the number of the image data already transmitted, before the image capturing apparatus is turned off because of the brownout.

29. A method according to claim 27, wherein:
the displaying displays the number of the image data already transmitted, after the image capturing apparatus is turned on again.

30. A method according to claim 21, further comprising:
determining whether the image capturing apparatus is in a state that is able to transmit the image data into the external apparatus, as a condition determination, when the image data that should be transmitted to the external apparatus but is not yet transmitted exists in the storage memory, after the image capturing apparatus is turned on again;
postponing the data transmission based on the condition determination; and
retransmitting the image data into the external apparatus, after the image capturing apparatus becomes in a state that is able to transmit the image data.

31. A computer program for controlling an image capturing apparatus having a communication function for transmitting image data that is captured, comprising:
transmitting the image data into an external apparatus, as a data transmission;
terminating the data transmission, when a voltage of a battery arranged in the image capturing apparatus detachably becomes equal to or less than a predetermined voltage, while the transmitting transmits the image data into the external apparatus;
storing the image data into a storage memory arranged in the image capturing apparatus, if the image data that is not yet transmitted is not yet stored in the storage memory, before the image capturing apparatus is turned off because of a brownout; and
re-transmitting the image data not yet transmitted into the external apparatus, after the image capturing apparatus is turned on again.

32. A computer program according to claim 31, further comprising:
storing a table data corresponding to the image data into the storage memory, before the image capturing apparatus is turned off because of the brownout; and
re-transmitting the image data not yet transmitted to the external apparatus, based on the table data, after the image capturing apparatus is turned on again.

33. A computer program according to claim 31, further comprising:
displaying a message which shows the image data was not transmitted completely into the external apparatus.

34. A computer program according to claim 31, further comprising:
displaying a number of the image data not yet transmitted into the external apparatus.

35. A computer program according to claim 34, wherein:
the displaying displays the number of said image data not yet transmitted, before the image capturing apparatus is turned off because of the brownout.

36. A computer program according to claim 34, wherein:
the displaying displays the number of the image data not yet transmitted, after the image capturing apparatus is turned on again.

37. A computer program according to claim 31, further comprising:
displaying number of the image data already transmitted into the external apparatus.

38. A computer program according to claim 37, wherein:
the displaying displays the number of the image data already transmitted, before the image capturing apparatus is turned off because of the brownout.

39. A computer program according to claim 37, wherein:
the displaying displays the number of the image data already transmitted, after the image capturing apparatus is turned on again.

40. A computer program according to claim 21, further comprising:
determining whether the image capturing apparatus is in a state that is able to transmit the image data to the external apparatus, as a condition determination, when the image data that should be transmitted to the external apparatus but is not yet transmitted exists in the storage memory, after the image capturing apparatus is turned on again;
postponing the data transmission based on the condition determination; and
retransmitting the image data to the external apparatus, after the image capturing apparatus becomes in a state that is able to transmit the image data.
